(19) United States
(12) Patent Application Publication
(10) Pub. No.: US 2026/0063045 A1
(43) Pub. Date: Mar. 5, 2026

(54) Reinforced Fan Inter-Blade Platforms

(71) Applicant: RTX Corporation, Farmington, CT (US)

(72) Inventor: Arun K. Theertham, Fort Worth, TX (US)

(73) Assignee: RTX Corporation, Farmington, CT (US)

(21) Appl. No.: 18/819,532

(22) Filed: Aug. 29, 2024

(51) Int. Cl. F01D 5/30

(52) U.S. Cl. CPC F01D 11/008; F05D 2220/36; F05D 2230/20; F05D 2230/60; F05D 2250/283; F05D 2300/603

(57) ABSTRACT

An inter-blade platform for a gas turbine engine fan has a body section including a fiber composite having: a forward end and an aft end; an outer diameter wall; a suction side wall; and a pressure side wall. The body section further comprises a core within the outer diameter wall.

### BACKGROUND

The disclosure relates to gas turbine engines. More particularly, the disclosure relates to fan inter-blade platforms or annulus fillers.

Such platforms are separately formed from the adjacent blades and separately mounted to the fan hub. The platforms have an outer diameter surface that locally forms the inner diameter gaspath surface through the fan.

One group of examples of such platforms are found in U.S. Pat. No. 10,557,361 (the '361 patent). Another group is found in US Patent Application Publication 20200355082A1 (the '082 publication). And another group is found in US Patent Application Publication 20220275727A1 (the '727 publication).

### SUMMARY

One aspect of the disclosure involves an inter-blade platform for a gas turbine engine fan. The platform comprises a body section including a fiber composite having: a forward end and an aft end; an outer diameter wall; a suction side wall; and a pressure side wall. The body section further comprises a core within the outer diameter wall.

In a further embodiment of any of the foregoing embodiments, additionally and/or alternatively, the core comprises: a honeycomb or a foam.

In a further embodiment of any of the foregoing embodiments, additionally and/or alternatively, the fiber composite comprises carbon fiber.

In a further embodiment of any of the foregoing embodiments, additionally and/or alternatively, the core has tapering fore, aft, pressure side, and suction side edge sections.

In a further embodiment of any of the foregoing embodiments, additionally and/or alternatively, the core is a single piece and the core extends for at least 50% of a length of the body section.

In a further embodiment of any of the foregoing embodiments, additionally and/or alternatively, the pressure side wall and the suction side wall do not have a core.

In a further embodiment of any of the foregoing embodiments, additionally and/or alternatively, the fiber composite surrounds a hollow interior containing brackets mounted to an interior surface along the pressure side wall and suction side wall and straddling respective apertures in a junction between the pressure side wall and suction side wall.

A further embodiment of any of the foregoing embodiments may additionally and/or alternatively include a pressure side seal mounted to the pressure side wall and a suction side seal mounted to the suction side wall.

A further aspect of the disclosure involves a fan including a plurality of the inter-blade platforms and further comprising: a hub; a plurality of fan blades mounted to the hub and each having an airfoil with a leading edge, a trailing edge, a pressure side, and a suction side. The plurality of inter-blade platforms are mounted to the hub and alternating with the plurality of fan blades so that the pressure side wall of each platform is to the pressure side of one adjacent airfoil and the suction side wall of each platform is adjacent the suction side of the other adjacent airfoil.

In a further embodiment of any of the foregoing embodiments, additionally and/or alternatively, each platform is mounted to the hub via a respective pair of a fore lug and an aft lug of the hub passing through apertures in a junction between the pressure side wall and suction side wall.

In a further embodiment of any of the foregoing embodiments, additionally and/or alternatively, the fiber composite surrounds a hollow interior containing brackets mounted to an interior surface along the pressure side wall and suction side wall and straddling respective said apertures in said junction between the pressure side wall and suction side wall.

A further aspect of the disclosure involves a method for manufacturing the inter-blade platform, the method comprising resin transfer molding wherein: fiber is wrapped around a mandrel; the core is assembled to the fiber-wrapped mandrel; further fiber is wrapped around the assembly; the fiber-wrapped assembly is placed in a mold; resin is injected into the mold; and the resin-injected assembly is released from the mold.

A further aspect of the disclosure involves a method for manufacturing an inter-blade platform. The platform comprises a body section including a fiber composite having: a forward end and an aft end; an outer diameter wall; a suction side wall; and a pressure side wall. The method comprises: wrapping fiber around a mandrel; assembling the core to the fiber-wrapped mandrel; and wrapping further fiber around the assembly.

A further embodiment of any of the foregoing embodiments may additionally and/or alternatively include: placing the fiber-wrapped assembly in a mold; injecting resin into the mold; and releasing the resin-injected assembly from the mold.

A further embodiment of any of the foregoing embodiments may additionally and/or alternatively include removing the mandrel.

A further aspect of the disclosure involves an inter-blade platform comprising:
a body section including a fiber composite having: a forward end and an aft end;
an outer diameter wall; a suction side wall; and
a pressure side wall. The outer diameter wall comprises: means for resisting outward bowing under centrifugal load.

In a further embodiment of any of the foregoing embodiments, additionally and/or alternatively, the means is inside the outer diameter wall.

In a further embodiment of any of the foregoing embodiments, additionally and/or alternatively, the means comprises a core fully encapsulated in the fiber composite.

In a further embodiment of any of the foregoing embodiments, additionally and/or alternatively, the fiber composite surrounds a hollow interior containing brackets mounted to an interior surface along the pressure side wall and suction side wall and straddling respective apertures in a junction between the pressure side wall and suction side wall.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a fan.

FIG. 2 is a front view of an inter-blade platform.

FIG. 3 is a rear view of the inter-blade platform of FIG. 2.

FIG. 4 is a front view of the inter-blade platform of FIG. 2 with seals removed.

FIG. 5 is a rear view of the inter-blade platform of FIG. 4.

FIG. 6 is a longitudinal sectional view of the inter-blade platform of FIG. 4, taken along line 6-6 of FIG. 4.

FIG. 7 is a transverse sectional view of the inter-blade platform of FIG. 4, taken along line 7-7 of FIG. 4.

Like reference numbers and designations in the various drawings indicate like elements.

### DETAILED DESCRIPTION

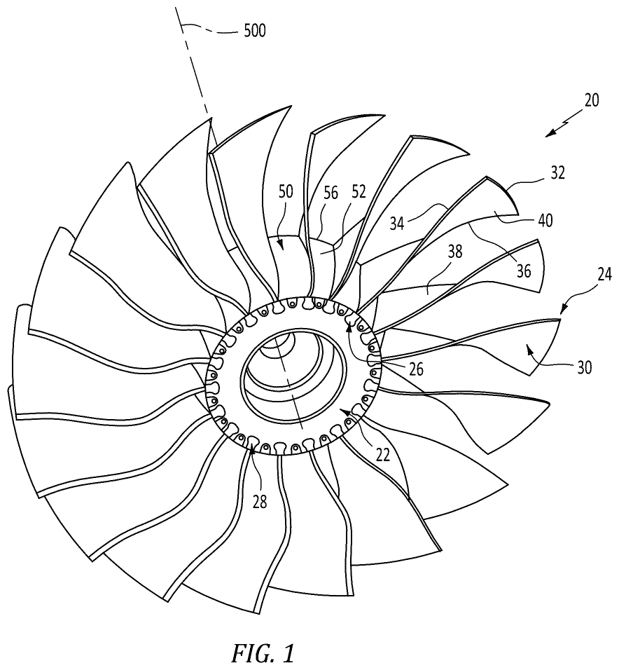

FIG. 1 shows a fan 20 having a hub 22 and a circumferential array of fan blades 24 mounted to the hub. A central longitudinal axis 500 may nominally be shared with the remaining rotors of the engine and form their axes of rotation. As example mounting features, each blade has a mounting root 26 received in an associated mounting slot 28 in the outer diameter (OD) periphery of the hub 22. Each blade has an airfoil 30 extending radially outward from the root to a tip 32. Each airfoil has a leading edge 34 and a trailing edge 36. Each airfoil has a pressure side 38 and a suction side 40.

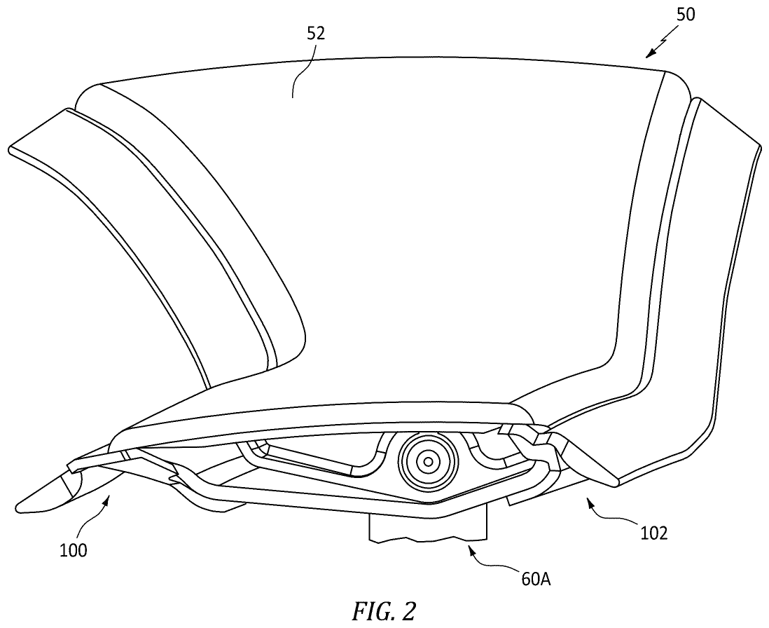

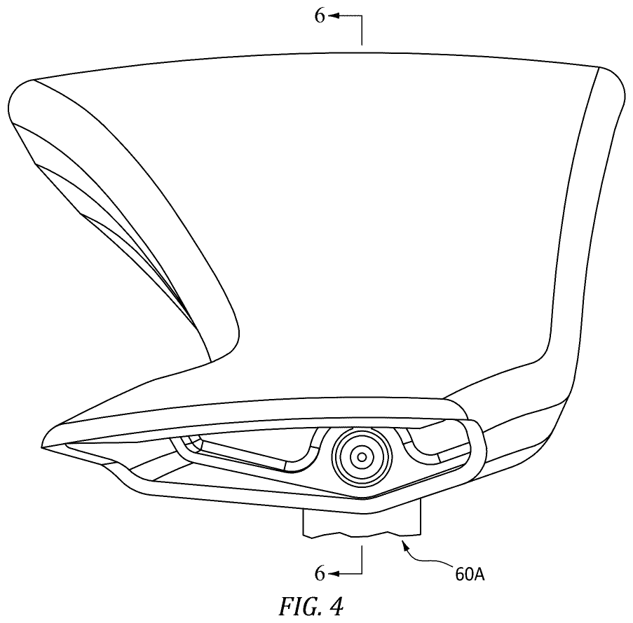

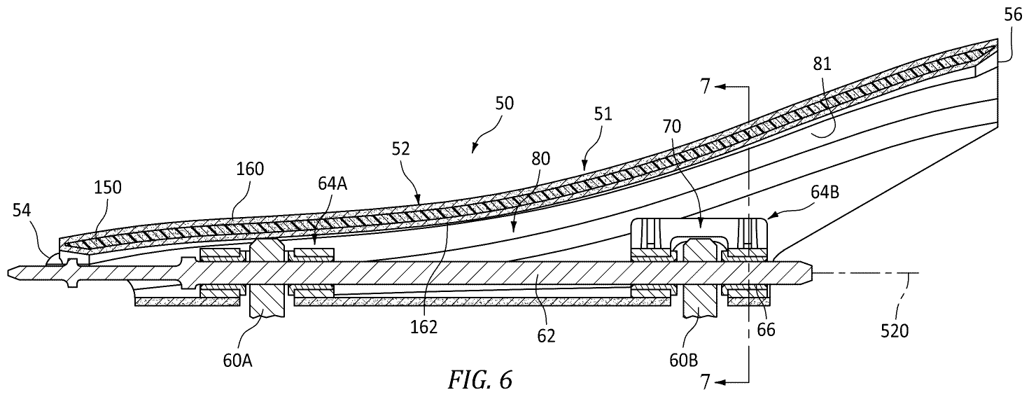

Between each adjacent blade is an inter blade platform 50 also mounted to the hub. Platform 50 and a main body 51 (FIG. 6) thereof has an outer diameter (OD) surface 52 which forms an inner diameter boundary of the air flow path or gaspath through the fan. FIGS. 2 & 3 show the platform 50 with seals 100, 102 for engaging adjacent blades (discussed below). FIGS. 4-7 show it without the seals.

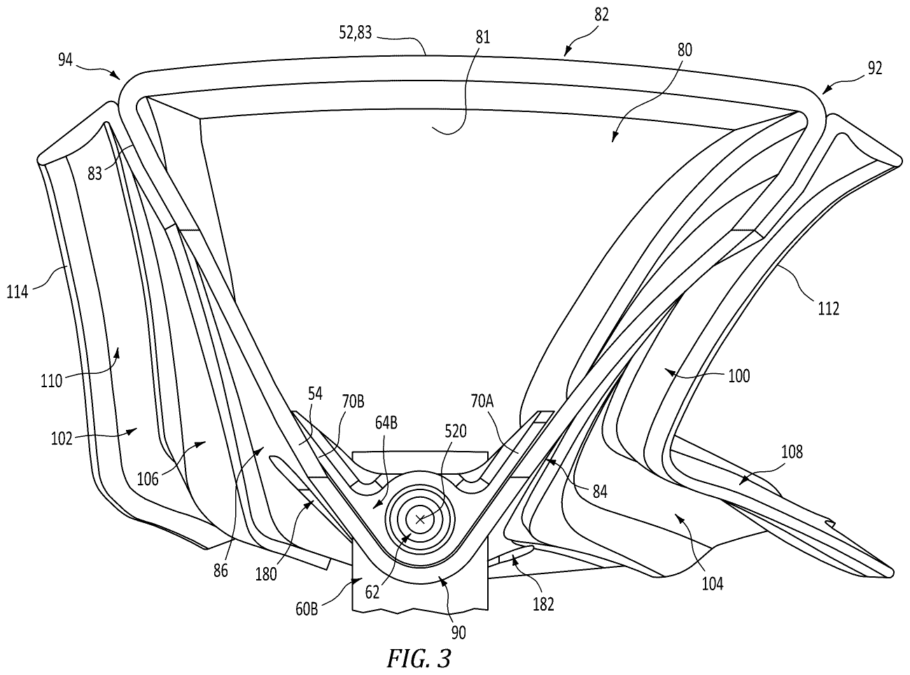

FIG. 6 shows the platform 50 mounted to the hub via a pair of radially-protruding fore and aft mounting lugs 60A and 60B of the hub. A pin 62 extends through apertures of the lugs and has a central axis 520 coaxial with such apertures. The pin also extends through fore and after brackets 64A and 64B of the platform 50. In the illustrated example, each of the brackets 64A, 64B has a forward/fore section and an aft/rear section each bearing a bushing 66 receiving the pin. The fore and aft sections of each bracket are connected by a body structure 70. The body structure 70 forms a pair of mounting wings 70A, 70B (FIG. 3) along the interior of the pressure side wall and suction side wall.

The platform 50 and the main body section 51 thereof extend from a forward/fore end 54 to an aft/rear end 56. The body 51 is generally hollow having an interior 80 largely bounded by an interior surface 81. The body generally includes an outer wall 82, a suction side wall 84, and a pressure side wall 86. The suction side wall 84 faces or contacts the suction side of one adjacent blade airfoil; whereas the pressure side wall 86 faces or contacts the pressure side of the other adjacent blade airfoil. The OD or gaspath surface 52 is, thus, a portion of and overall outer surface 83 of the main body 51.

FIG. 3 shows the main body 51 as including an inner diameter/inboard junction or turn 90 joining or between the pressure side wall 84 and the suction side wall 86. FIG. 3 also shows respective junctions or turns 92 and 94 between the outer diameter wall 82 and respectively the pressure side wall and suction side wall. The resulting cross-section resembles a rounded-corner triangle with a hollow interior. The OD wall is bowed outward and the side walls converge toward each other to join the junction 90. The side walls may also bow slightly inward or outward.

FIG. 3 also shows a pressure side seal 100 and a suction side seal 102 respectively mounted to the pressure side wall and suction side wall for contacting and sealing with the respective adjacent blades. Example seals 100 and 102 are elastomeric and have a mounting section 104, 106 mounted to the associated pressure sidewall or suction sidewall such as via adhesive. A sealing section 108, 110 extends circumferentially outward to engage the associated blade such as at a distal edge 112, 114.

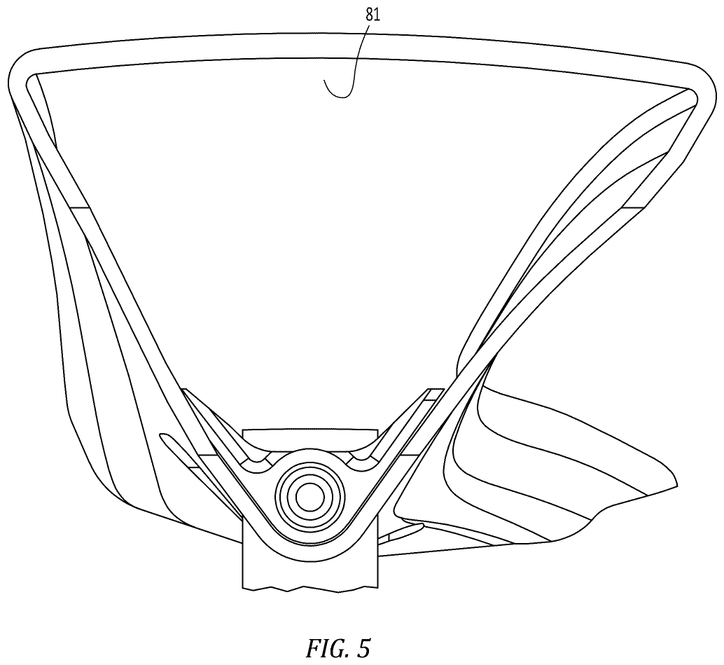

The main body 51 principally comprises a fiber composite such as a carbon fiber composite. As so far described in this section, the platform represents one example of a baseline that may be modified as follows. As noted in the '361 patent, circumferential loading may outwardly bow the OD wall 82 when viewed in transverse section. '361 patent FIG. 5 and accompanying discussion highlight interlaminar stresses at the present junctions or turns 92 and 94 associated with such loading/bowing.

The modification adds a lightweight core 150 to the OD wall 82. In the illustrated example, there is no such core added to the side walls. One example core material is a polymeric honeycomb (e.g., of an aramid such as a meta-aramid (e.g., poly (meta-phenyleneisophthalamide)). Alternative honeycombs include carbon fiber or metal (e.g., aluminum or an alloy thereof). Another core material is a foam (e.g., polymeric such as polymethacrylimide (PMI)). The core may thus be less dense than the fiber composite surrounding it both as a pure material but, even more so, when including the porosity (e.g., air or other gas-filled) within the core. The nonmetallic honeycomb core or foam core may be molded. Or those or other cores may be cut/machined form larger stock. The OD wall 82 thus includes one or more outer fiber layers 160 and one or more inner fiber layers 162. The core 150 is thus distinguished from a core that acts as a mandrel and is left in place filling the interior of the fiber composite.

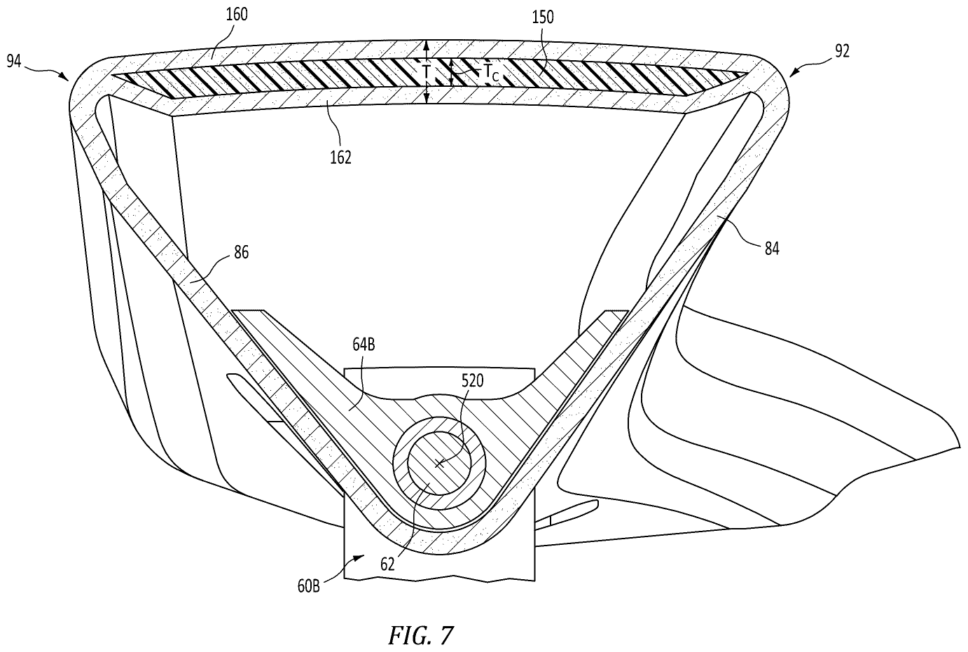

Component materials and manufacture techniques and assembly techniques may be otherwise conventional. Example manufacture of the main body is via resin transfer molding. Additionally, for example, during the wrapping of the fiber tows or tapes, the core may be integrated. For example, the tows or tapes may initially be wrapped over a sacrificial mandrel until sufficient thickness has been built up to create the inner layers 162 the core 150 may be applied over the fiber at this point and then wrapping completed forming the full thickness of the side walls and forming the outer layers 160. The edges of the example core are tapered to allow the composite plies to cleanly drape and transition the laminate from a sandwich structure to a monolithic laminate. The layup may be placed in a die and resin injected. The core may represent a substantial fraction of the local thickness of the combined fiber layup and core. For example, an example local core thickness T_{C} (FIG. 7) may represent an example at least 30% of the total thickness T of the combination. In FIG. 7, the thicknesses are labeled in the cut plane but would actually be measured normal to the inner and outer surfaces. More particularly, example T_{C} is 30% to 80% of T, and, more narrowly, 50% to 80% of T. This ratio may exist along a majority of the footprint of the core but, clearly, may not include features such as tapered edge portions of the core. In terms of area, example cores may represent at least 50% of the footprint of the fiber body (e.g., when viewed radially inward in the engine frame of reference).

Alternatively, the core may be initially wrapped in one or more layers and then the wrapped core integrated with the remaining layers as discussed above.

After removal from the die, fore and aft apertures 180, 182 may be cut/machined if not already formed by wrapping around a portion of the mandrel. The apertures span the junction 90 and may extend partially up the side walls toward the OD wall. These apertures ultimately accommodate the hub lugs 60A, 60B and are respectively longitudinally straddled by the brackets 64A, 64B. The brackets 64A, 64B may be machined of an alloy or may be molded of a polymeric material and/or a fiber composite such as a fiber filled polymer. They may be inserted and adhered in place such as via epoxy. In yet other embodiments, the brackets may be integrated in the wrapping of the fiber tows or tapes.

In various embodiments, the addition of the core may provide a beneficial combination of weight and structural integrity. For example, while preserving weight, structural integrity may be improved. Alternatively, while preserving structural integrity, weight may be reduced. Or, weight may increase but structural integrity may disproportionately increase. In various, embodiments, the weight may be less than a core-less body or wall of the same thickness profile (e.g., where ethe space occupied by the core is instead occupied by the same fiber composite used elsewhere in the main body).

The example core 150 is a single core that extends a substantial fraction of both the longitudinal and circumferential span of the OD wall 82. However, alternative embodiments may have other configurations. Among possible variations are multiple longitudinally-spaced segments but with similar transverse/circumferential extent. This may allow webs of the carbon fiber between the segments and joining the outer and inner layers 160, 162 to add rigidity as in the web of an I-beam joining the two flanges. Thus, whether segmented or unsegmented, an example core or combination of cores may account for at least 50% of an area of the outer wall 82 and has a longitudinal span or a combined longitudinal span of at least 50% of that of the body and each have a circumferential span of at least 50% of that of the body locally.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline fan configuration, details of such baseline may influence details of particular implementations. Accordingly, other embodiments are within the scope of the following claims.

1. An inter-blade platform for a gas turbine engine fan, the platform comprising:
a body section including a fiber composite having:
a forward end and an aft end;
an outer diameter wall;
a suction side wall; and
a pressure side wall,
wherein:
the body section further comprises a core within the outer diameter wall and having tapering fore, aft, pressure side, and suction side edge sections;
the outer diameter wall comprises one or more outer fiber layers and one or more inner fiber layers and the core is sandwiched between the one or more outer fiber layers and the one or more inner fiber layers; and
at the tapering fore, aft, pressure side, and suction side edge sections one or more outer fiber layers and one or more inner fiber layers cleanly drape and transition a laminate structure from a sandwich structure including the core to a laminate without the core.

2. The inter-blade platform of claim 1 wherein the core comprises:
a honeycomb.

3. The inter-blade platform of claim 1 wherein the core comprises:
a foam.

4. The inter-blade platform of claim 1 wherein:
the fiber composite comprises carbon fiber.

5. The inter-blade platform of claim 1 wherein:
the core is along at least 50% of an area of the outer diameter wall.

6. The inter-blade platform of claim 1 wherein:
the core is a single piece; and
the core extends for at least 50% of a length of the body section.

7. The inter-blade platform of claim 1 wherein:
the pressure side wall and the suction side wall do not have a core.

8. The inter-blade platform of claim 1 wherein:
the fiber composite surrounds a hollow interior containing brackets mounted to an interior surface along the pressure side wall and suction side wall and straddling respective apertures in a junction between the pressure side wall and suction side wall.

9. The inter-blade platform of claim 1 further comprising:
a pressure side seal mounted to the pressure side wall; and
a suction side seal mounted to the suction side wall.

10. A fan including a plurality of inter-blade platforms of claim 1 and further comprising:
a hub;
a plurality of fan blades mounted to the hub and each having:
an airfoil with a leading edge, a trailing edge, a pressure side, and a suction side; and
said plurality of inter-blade platforms mounted to the hub and alternating with the plurality of fan blades so that the pressure side wall of each platform is to the pressure side of one adjacent airfoil and the suction side wall of each platform is adjacent the suction side of the other adjacent airfoil.

11. The fan of claim 10 wherein:
each platform is mounted to the hub via a respective pair of a fore lug and an aft lug of the hub passing through apertures in a junction between the pressure side wall and suction side wall.

12. The fan of claim 11 wherein:
the fiber composite surrounds a hollow interior containing brackets mounted to an interior surface along the pressure side wall and suction side wall and straddling respective said apertures in said junction between the pressure side wall and suction side wall.

13. A method for manufacturing the inter-blade platform of claim 1, the method comprising resin transfer molding wherein:
fiber is wrapped around a mandrel;
the core is assembled to the fiber-wrapped mandrel;
further fiber is wrapped around the assembly;
the fiber-wrapped assembly is placed in a mold;
resin is injected into the mold; and
the resin-injected assembly is released from the mold.

14. The inter-blade platform of claim 1 wherein:
the core comprises a honeycomb or a foam; and
the core extends for at least 50% of a length and circumferential span of the body section.

15. (canceled)

16. (canceled)

17. An inter-blade platform comprising:
a body section including a fiber composite having:
a forward end and an aft end;
an outer diameter wall;
a suction side wall; and
a pressure side wall,
wherein the outer diameter wall comprises:
means sandwiched between layers of the outer diameter wall for resisting outward bowing under centrifugal load, the means comprising a core fully encapsulated by the fiber composite; and
wherein:
the means comprising a core fully encapsulated by the fiber composite such that at fore, aft, pressure side, and suction side edge sections of the core one or more outer fiber layers of said layers and one or more inner fiber layers of said transition a laminate structure from a sandwich structure including the core to a laminate without the core.

18. The inter-blade platform of claim 17 wherein:
the means comprises a honeycomb or foam.

19. (canceled)

20. The inter-blade platform of claim 17 wherein:
the fiber composite surrounds a hollow interior containing brackets mounted to an interior surface along the pressure side wall and suction side wall and straddling respective apertures in a junction between the pressure side wall and suction side wall.

21. An inter-blade platform for a gas turbine engine fan, the platform comprising:
a body section including a fiber composite having:
a forward end and an aft end;
an outer diameter wall;
a suction side wall; and
a pressure side wall,
wherein the body section further comprises:
a core within the outer diameter wall between one or more outer fiber layers of the outer diameter wall and one or more inner fiber layers of the outer diameter wall, wherein the pressure side wall and the suction side wall do not have a core; and
wherein the fiber composite surrounds a hollow interior containing brackets mounted to an interior surface along the pressure side wall and suction side wall and straddling respective apertures in a junction between the pressure side wall and suction side wall.

22. The inter-blade platform of claim 21 wherein:
the core comprises a honeycomb or a foam.

23. The inter-blade platform of claim 21 wherein:
the core is along at least 50% of an area of the outer diameter wall.
